(19) United States
(12) Patent Application Publication
(10) Pub. No.: US 2008/0263088 A1
(43) Pub. Date: Oct. 23, 2008

(54) Spatial Data Management System and Method

(76) Inventors: CORRAN WEBSTER, Las Vegas, NV (US); WILLIAM COLEMAN, Las Vegas, NV (US); ANDREW JOHN CARDNO, Henderson, NV (US)

Correspondence Address: COMPUDIGM SERVICES INC., 6757 SPENCER STREET, LAS VEGAS, NV, 89014, US

(21) Appl. No.: 11/941,926

(22) Filed: Nov. 17, 2007

(30) Foreign Application Priority Data
Nov. 16, 2006 (NZ) NZ551348

(51) Int. Cl. G06F 17/30

(52) U.S. Cl. 707/103 R; 707/E17.018; 707/E17.055

(57) ABSTRACT

A spatial data management system including a spatial database maintained in computer memory, the spatial database including one or more position data sets, the position data sets including respective objective identifiers, geographical data and date/time data. The system also includes an analysis engine configured to retrieve one or more position data sets from the spatial database and to generate display data at least partly from the retrieved position data sets. The system further includes a layout manager configured to receive the display data from the analysis engine and to display to a user a graphical spatial representation of the display data which allows relevant analysis of past performance and/or projections for future performance based on changes to spatial layouts.

### FIELD OF INVENTION

The invention relates to a spatial data management system and method. The system and method is particularly but not solely designed for analysing data relating to layouts of casino floors, retail stores, websites and warehouses.

### BACKGROUND TO INVENTION

The question of what product to offer in what location within a store or place of business is a critical one to business managers. Whether it is the question of where to locate goods on the display shelves of a retail store, slot machines on a casino floor, or goods or services on the pages of a commercial website, the essential problem remains the same. How can one select in a range these objects to optimise revenue, profit or other key performance indicator (KPI) of the business location.

Our patent specification WO 00/79438 titled “Spatial Data Management System and Method” describes a system for manipulating the location of gaming machines and other relocatable objects within a casino. The system provides a convenient and user friendly system to record changes to floor layouts.

It would be particularly advantageous to provide a spatial data management system and method that additionally displays relevant analysis of past performance and/or projections for future performance based on changes to spatial layouts.

It is an object of the present invention to provide an improved or alternative spatial data management system and method, or to at least provide the public with a useful choice.

### SUMMARY OF INVENTION

In one aspect of the invention there is provided a spatial data management system. The system includes a spatial database maintained in computer memory, the spatial database including one or more position data sets, the position data sets including respective objective identifiers, geographical data and date/time data. The system also includes an analysis engine configured to retrieve one or more position data sets from the spatial database and to generate display data at least partly from the retrieved position data sets. The system further includes a layout manager configured to receive the display data from the analysis engine and to display to a user a graphical spatial representation of the display data.

The term “comprising” as used in this specification and claims means “consisting at least in part of”. That is to say, when interpreting statements in this specification and claims which include “comprising”, features, other than those prefaced by this term in each statement can also be present. Related terms such as “comprise” and “comprised” are to be interpreted in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE FIGURES

Preferred forms of the spatial data management system and method will now be described with reference to the accompanying figures in which:

FIG. 1 shows a block diagram of a system in which the invention is implemented.

FIG. 2 shows a preferred form database schema.

FIG. 3 shows sample data for transaction records, product records, customer records and location records.

FIG. 4 shows sample data of products within locations for each floor plan.

FIG. 5 shows a typical neural network suitable application with this invention.

FIG. 6 shows aggregation of the data for a retail location.

FIG. 7 shows a retail example in which a table provides a series of vectors.

FIG. 8 shows how the cells the self organising map could be stored in a table.

FIG. 9 shows how further information can be stored in a table.

FIG. 10 shows a visual representation of a preferred form layout manager.

### DETAILED DESCRIPTION OF PREFERRED FORMS

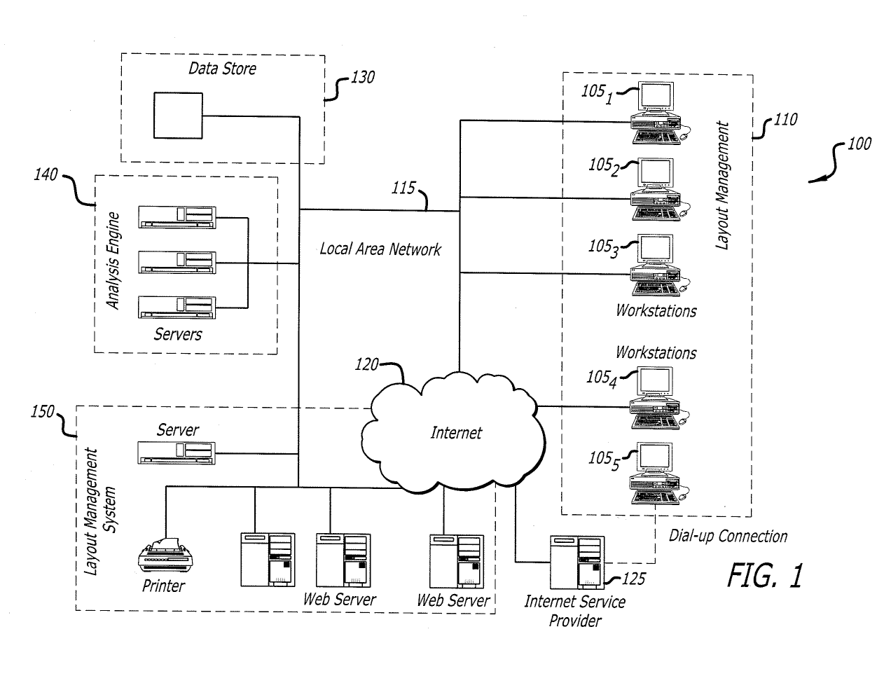

FIG. 1 illustrates a block diagram of a preferred system 100 in which the present invention is implemented. The system includes one or more workstations 1051, 1052, 1053, 1054 and 1055. Workstations 105 are referred to as layout managers 110. The workstations include individual workstations on which is installed and operating layout manager software as will be described below.

The workstations 105 are interfaced to other components of system 100 by for example a local area network 115, one or more internet networks 120 or a dial up connection through an internet service provider 125.

System 100 includes a data store 130. The data store in turn includes one or more separate computer systems. The data store will be described in further detail below. A spatial database is maintained within data store 130. The spatial database includes one or more position data sets, the position data sets including respective object identifiers, geographic data and date/time data. Also stored in the data store is an event database of events data representing one or more events involving one or more of the objects in the spatial database.

System 100 includes an analysis engine 140. The analysis engine includes one or more servers. The engine includes appropriate software that is configured to retrieve one or more position data sets from the data store 130 to generate display data at least partly from these retrieved position data sets. Some of the display data sets arise from analysis performed by the analysis engine. Examples of functions performed by the analysis engine include predicting the performance of changes made to layouts stored in the data store. These techniques include the use of neural networks, regression methods, classification methods and the recommendation of optimal placement based on the foregoing methods. The analysis engine 140 will be further described below.

System 100 optionally includes a layout management system 150. System 150 includes a server, one or more web servers and a printer. The layout management system is configured to receive changes to layouts and automatically generate work orders to implement those changes at a specified time. For example, a retail store layout manager may allow the user to generate a work order to be sent to store managers when new product is sent to the store, instructing the manager on the appropriate placement of the products. This location management system can be automated if the layout can be changed electronically or mechanically. For example, a retail website could be updated automatically with new web pages and linkages based upon changes made in the layout manager. Layout management system takes product location specified by the layout manager and automatically generates the needed changes to html or the website software to implement the changes specified for the new design.

The layout management system in one form is also used to keep track of required upkeep and maintenance, generating work orders for routine tasks. The work orders may use information from the analysis engine to, for example, show the current location of a machine on the slot floor, or indicate things which particular attention should be paid to. The layout management system could also look for anomalous data for a location, and generate alerts or work orders to have the location inspected. For example, if a slot machine were to stop generating turnover in an unusual way, the management system might generate a work order to have the machine inspected for a burnt out CRT for example. If a certain product were to stop selling in a store then an alert might be generated to check that the product had not run out of stock on the shelves.

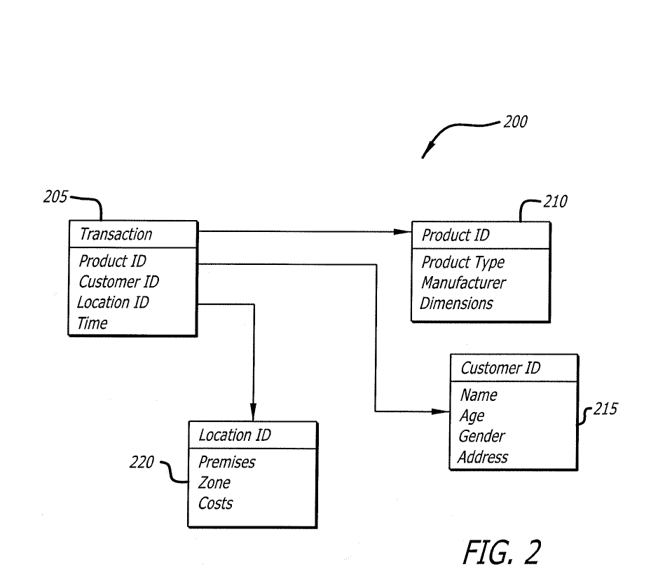

FIG. 2 illustrates a preferred form database schema 200 suitable for maintaining position data representing the location of one or more objects.

Schema 200 includes a transaction table 205. A typical transaction record includes a product identifier, a customer identifier and a location identifier. The product identifier identifies the products involved in the transaction. A product identifier includes a retail product SKU or other product identifiers or a slot machine identifier or perhaps a slot machine game if multi game machines are being tracked in a casino.

A customer ID records the customer involved in the transaction. The customer ID is captured in one version by a loyalty card programme or scheme.

The location identifier records where a transaction occurred. The location identifier is an appropriate identifier that links to location information.

Other detail included in a transaction record includes the transaction time, any discounts, coupons or other special offers applied to the transaction, the total revenue from the transaction, the amount of products purchased, the total cost of the transaction such as the cost of the goods involved in a retail transaction and other relevant information. In some circumstances a web based store might also keep track of the products which a customer looked at but didn't buy and store that with the transaction information.

Data schema 200 also includes a product table 210. The product table includes a product identifier such as the SKU or other ID for the product which is used in the transaction records. A product type defines the type of product. This could be possibly several fields from broad classifications or alternatively could be very narrow such as slot machine game type and/or the actual game for a casino. The product table could also include manufacturer details, dimensions of the product, configuration (for downloadable games in a casino) and other relevant information.

Customer table 215 includes a customer identifier similar to the transaction table 205, name of the customer, age, gender, address, telephone number, hobbies and interests, occupation, income, spouse or other family members and other relevant information.

Location table 220 includes a location identifier such as that used in transaction table 205. Location table 220 also includes the premises of the location (such as a store casino etc, the zone in the premises, costs associated with the location, the market of the premises, and other relevant information.

The actual data may be stored in a different form and aggregated by the data store to appear in an aggregated form to the other parts of the system. Alternatively, aggregation may be performed by the analysis engine if the data is not present in the system. One example is that the location ID could be derived by the store from a combination of product ID and time, in conjunction with the product location data store described below.

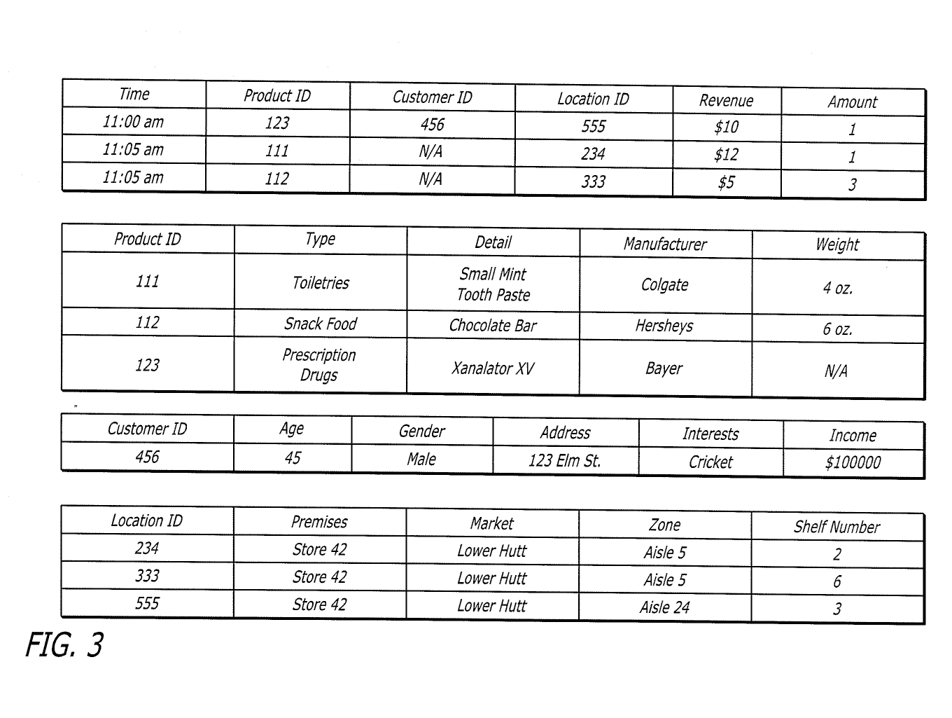

FIG. 3 shows sample data for transaction records 300, product records 305, customer records 310 and location records 315.

The data store also includes floor plans. These floor plans in one form are stored using a plurality of files in a file system or records in a database that hold data in a common format used by CAD software. Typical formats include AUTOCAD format, .mid/.mif format, or a custom format.

A typical floor plan contains multiple layers. Each layer represents a specific class or type of object or piece of information. For example, there might be a layer holding the representations of the walls, another holding the representation of shelves in a retail store, another layer holding textual descriptions for display, another holding zones within the premises, and another holding the locations where products can be placed.

Each layer contains a list of objects, each of which consist of an object ID that can be used by other parts of the system to refer to the object and information describing the location, orientation, size or other spatial data appropriate for the object. This might be for instance a series of points which describe the vertices of the polygon where the object is, the text to be displayed with the object, or other information about the object or the way the object is to be displayed.

The preferred format is .mid/.mif file formats to hold the floor plans.

The location of products in floor plans consists of a table associated with some version of a floor plan that associates object identifiers with appropriate location identifiers, together with a table that associates location identifiers with product identifiers.

A series of tables is stored in computer memory together with a record of times when these floor plans and product locations are in effect, were in effect, or are planned to be in effect.

In one version the two tables of relationships are achieved by respectively a series of directories containing time stamps in the floor plan files and a table in a database describing which products are in which locations for each floor plan.

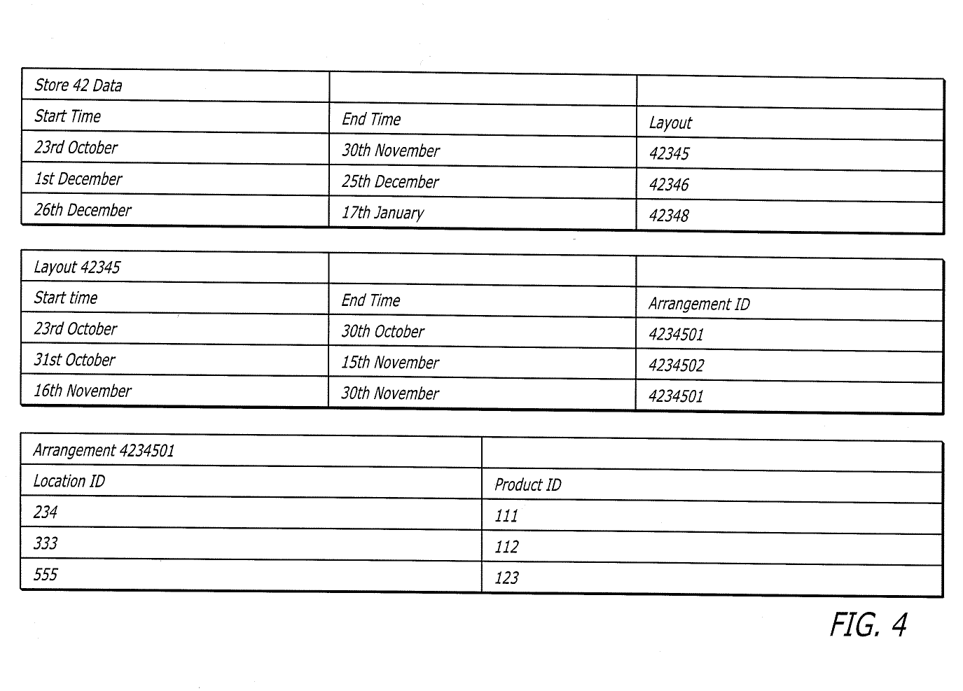

FIG. 4 shows sample data of products within locations for each floor plan.

The analysis engine is intended to provide predictions of behaviour. The engine may predict behaviour of a current or past layout by analysing the historical data in the data store and using statistical or artificial intelligence (AI) techniques to predict future behaviour.

One method of predicting behaviour is to fit a regression model to historical data, and use that regression model to project that data forward. One technique of predicting future performance of a product in a location uses linear regression.

A finite family of linearly independent functions ƒₖ(t) are chosen. For example, if a cubic function is desired, the functions to be used is f₁(t)=1, f₁(t)=t, f₁(t)=t², f₁(t)=t³.

Data values are retrieved from the data store and aggregates of those data values are compiled to form the sample values on which the regression is performed. For example, the total transaction revenue associated with a particular product in a particular location is totalled for each week. An example table produced from the data described above for product ID 123 in location ID 555 is set out below:

| t | 1 | 2 | 3 | 4 | 5 |
|---|---|---|---|---|---|
| y | $1000 | $1100 | $1110 | $1050 | $1150 |

In the above table, the value t is measured in weeks and y is the total revenue for that product in that location for that week. This table can be built from the transaction table by finding all transactions that match a time period, product and location and by adding the appropriate values.

A matrix X is compiled whose values are the value of each function evaluated at each of the sample points t. The matrix is formally defined as X=[ƒₖ(tᵢ)]ᵢₖ. In the example above the matrix values are as follows:

$$X = [ \begin{matrix}1 & 1 & 1 & 1 \\ 1 & 2 & 4 & 8 \\ 1 & 3 & 9 & 27 \\ 1 & 4 & 16 & 64 \\ 1 & 5 & 25 & 125\end{matrix} ]$$

The matrix equation \hat{α}=(X^{T} X)⁻¹ X^{T} y̅ is solved. In this equation y̅ is the column vector of y-values from the sample points and \hat{α} is the column vector of optimal coefficients for the predictor function. In the above example, the \hat{α} values are set out below:

$$\hat{α} = [ \begin{matrix}622 \\ 546.67 \\ - 192.5 \\ 20.833\end{matrix} ]$$

The predictor function is therefore ƒ(t)=622+546.67t−192.5t²+20.833t³.

The predictor function is then used to calculate the estimated value of y at the desired t. In the example above it may be of interest to calculate the value in the 6^{th} week. This value is calculated as ƒ(6)=622+546.67×6−192.5×36+20.833×216=1472.

In practice, for the sorts of applications being considered within the scope of these techniques, the model would typically use a simple linear function of a form ƒ(t)=α+bt.

It is anticipated that more sophisticated regression models will be used if they can be shown to fit data better in general. For example, generalised linear regression is used in some techniques. In this method, data is passed through a function go. Linear regression is then performed on the modified data and then the inverse function is applied to the predicted value.

Non linear regression is used to fit the data to a family of curves of the form

y=ƒ(t, α̅.

Vector α̅ is a vector of parameters that determine the shape of the curve. One method of finding the optimal parameters is to use Newton's method to find the minimum values for an error function such as the function E:R^{d}→R where

$$E ( \vec{α} ) = {\sum }_{k = 1}^{n} {( {y}_{k} - f ( {x}_{k} , \vec{α} ) )}^{2}$$

This would involve finding the partial derivatives of E and solving the system of equations

$$\frac{\partial E}{\partial {α}_{i}} = 0 , \\ i = 1 , … , d$$

$$Letting$$

$$F ( \vec{α} ) = {( \frac{\partial E}{\partial {α}_{i}} ( \vec{α} ) )}_{i = 1}^{d}$$

Newton's method solves this by finding a sequence tₙ of vectors satisfying

J_{F}(tₙ)(tₙ₊₁−tₙ)=−F(tₙ)

where J_{F} is the Jacobian of partial derivatives of F.

The above method may be particularly useful for fitting data to sigmoid curves of the form

$$f ( t ) = \frac{A}{1 + B {e}^{Ct}} + D$$

since this appears a good model of slot machine performance over a long period of time.

The above example is one example of non linear regression that is appropriate for use with these techniques.

Another technique for predicting behaviour of a product is the use of a neural network. In one technique the analysis engine uses a back propagation neural network to model “coin in” or “drop” of a particular slot machine based upon the behaviour of other independent machines in a casino. If the slot machine is replaced, the analysis engine can use the neural network to provide a prediction to the layout manager of how the machine might have behaved based upon the observed behaviour of the independent machines.

A back propagation neural network is a network consisting of three layers of nodes, each layer connected to the next by a complete graph of weighted edges. Input data is fed into the first layer. The data is then weighted, combined and presented to the next layer. The next layer calculates a sigmoid function for each node. The data is then weighted and combined and passed back to the final layer. The results are compared with known output data.

The error in the output is then propagated backwards. The weights of the edges are adjusted so that the edges carrying more of the error are given less weight. This process is repeated until the output of the neural network matches the known data sufficiently well. Some data may be held back from training. The data held back is instead used to validate the neural network to ensure that it does not fit the training data too well at the expense of more general data.

The inputs in one form comprise total revenue for a series of days for three or four slot machines. The machines are selected to be largely independent of the slot machine that is to be predicted. These input machines must have unchanged position and location over the sample period and the prediction period. The known output data is the total revenue for the slot machine of interest for those days.

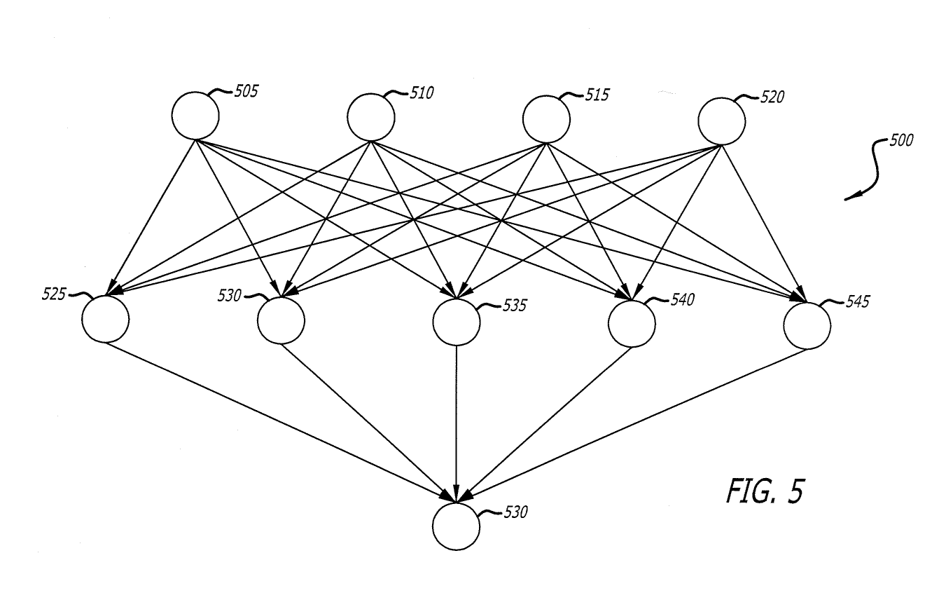

FIG. 5 shows a typical neural network suitable for application with the above techniques. The neural network 500 includes a first layer having four nodes 505, 510, 515 and 520. Input data is weighted and fed to the next layer having nodes 525, 530, 535, 540 and 545.

The final layer includes node 550.

The output of the network is

$$y = {\sum }_{k = 1}^{5} {w}_{k} f ( {\sum }_{j = 1}^{4} {u}_{k , j} {x}_{j} ) .$$

The values xⱼ are input values. The values u_{k,j} are the edge weights for the first layer. The values wₖ are the edge weights for the second layer. Function f is the response function.

The neural network 500 is trained as described above until it matches the data sufficiently well. The model can then be used to predict the performance of the output slot machine based on the performance of the other slot machines over a given time period. If the target slot machine is replaced by another, the above model can be used to predict how the old slot machine would have done in the given time period.

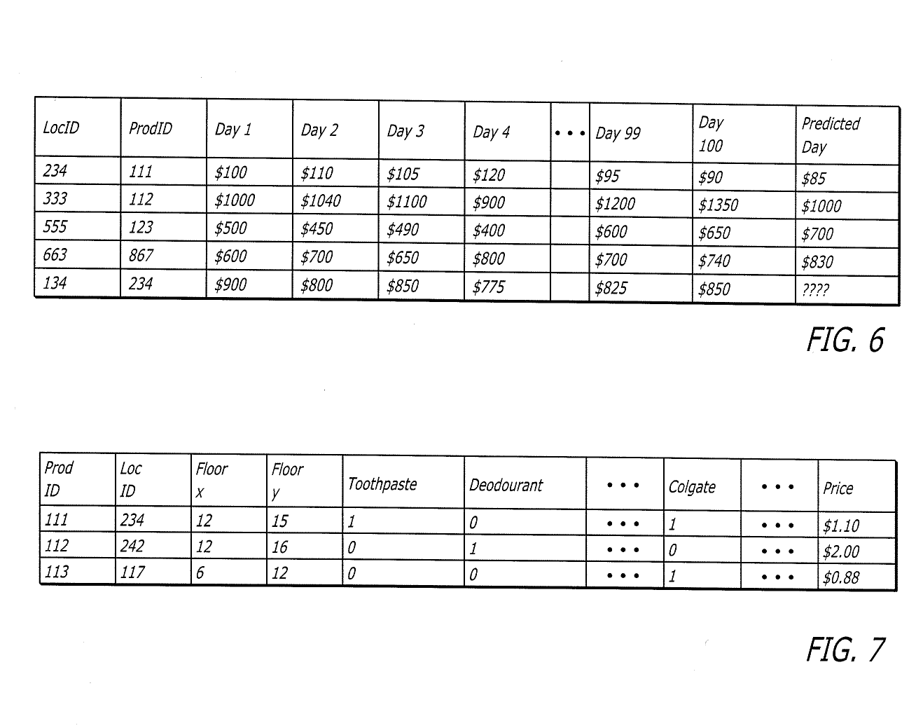

FIG. 6 shows aggregation of the data for a retail location. The product in location 134 is removed on day 101. Another product is substituted in its place. The prediction day is some point following that point. The neural network is trained on the data for the first 100 days. The value indicated by ???? is predicted using the inputs from the other products and locations with the neural network.

In a further preferred form embodiment, the analysis engine uses classification techniques to predict the behaviour of new products based on the behaviour of similar existing products. The analysis engine for example reads product data such as type of product, manufacturer, price or location from the data store and uses that data to create a self organising map of the products where similar products have similar behaviour in the store such as sales performance over time.

A self organising map is an array of cells. Each of the cells is linked to a vector. It is used to find clusters and relationships amongst data vectors. The self organising map can be used to predict behaviour by associating a new vector with an element in the array of vectors and using the known behaviour of vectors in that location to predict the behaviour of the new vector.

A self organising map is generated by starting with an array of vectors which is generated either randomly or by some other clustering method. Vectors are repeatedly drawn from a sample set and the closest matching vector in the map to the sample vector is located. This matching vector and its neighbours are then adjusted to be closer to the sample vector. Less adjustment occurs the further the neighbour is from the matching vector in the map array. Over many iterations the amount of adjustment is decreased until eventually the map stabilises. The map then has clusters of similar vectors clustered together.

There are variants of this system where the map grows in size as it is generated. There are also variants of the system where parallel optimisations are used to generate the map more quickly. It is anticipated that such variants are included within the scope of the above techniques.

In predicting behaviour, for each product ID and location ID combination, a vector is created that might consist of spatial data of the location for example floor location and perhaps height above the floor. Also included is classification data such as product type, manufacturer, form factors. For example a 1 in a dimension corresponding to each classification if the data matches the classification and 0 otherwise. Also included is physical information for example box size and weight. Sale price is also included. Any other data about the product that can be represented as a number can also be included. However, data that cannot be known before the product is made available, such as total revenues or turnover is held back from the vector.

A distance function is devised that weights different components of the vector different amounts. These weight amounts may have to be experimentally discovered but once good weights are found they can be used indefinitely. For example, it may be that the distance between locations on the slot floor is weighted twice as much as the difference between product categories.

FIG. 7 shows a retail example in which a table provides a series of vectors. The elements of each row that are in italics become the components of each vector.

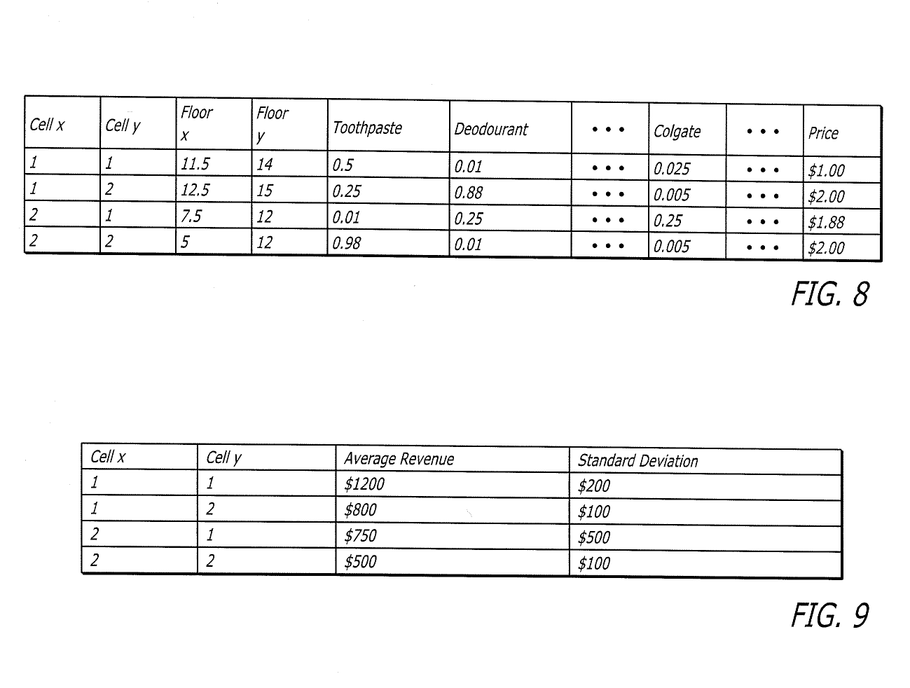

FIG. 8 shows how the cells in the self organising map could be stored in a table. For example, the product ID-location ID pair (113, 117) would have its closest match to the vector in cell (2,1).

Once a good map has been generated, each cell in the array that comprises the map is associated with some aggregate measure of the data that matches that cell. For example, the cell might be associated with the total revenue during the first month for each product that matches that cell, averaged over all the products and locations that match that cell.

When a new product becomes available and a potential location is considered, its vector is calculated and the closest match is found on the map to that vector. The associated information is then used to predict how it will perform. For example, the total revenue during the first month will likely be close to the average total revenue for other products matching that cell. Standard statistical methods such as standard deviation can be used to give an idea of the certainty of the prediction.

This information might be stored in a table as shown in FIG. 9.

A product that is being considered for placement in a store can be optimised by iterating over all possible placements, finding the closest matching cell for each, and finding the one that has the maximum (or minimum) average.

With sufficient data it may be possible to generate predicted optimal layouts by searching all possible arrangements of products in locations, and finding the one whose aggregate value is a maximum or minimum.

It is envisaged that the above techniques incorporate the normalisation of the data. The concept behind normalisation is rather than using absolute amounts for aggregates of transactions, to instead use proportions of the totals for the location. For example, rather than using the total revenue over a period of a week for a given location and a product to feed the prediction algorithms as described above, there might be the option to use the proportion of total revenue that comes from that product and locations.

This could be calculated by the total revenue of product at a location in a time period divided by the total revenue of store in time period.

Another way of normalising the data is to adjust the figures for seasonal or cyclic data. With several years of data a business could find trends in proportions over a period of a year, month, week or even day. For example, over a typical week, the following table might be compiled:

| Day of Week | Revenue % above or below average per day store-wide |
|---|---|
| Monday | −20% |
| Tuesday | −10% |
| Wednesday | −15% |
| Thursday | −10% |
| Friday | +25% |
| Saturday | +150% |
| Sunday | −25% |

This data could then be used to adjust both input data for predictive models in the actual predictions. For example, the total revenue of a product on Monday might be adjusted upward by dividing by 0.8 (80%) to reflect the fact that Monday revenues are on average 80% lower than on an average day.

The layout manager allows the user to change the layout of products within the business location. When a user is satisfied with the changes made to the business location's layout, changes are stored back to the data store, and optionally the changes may be sent to the location management system to create a work-order based upon the changes. In addition, the system may check for potential problems in the design, and issue warnings or errors. For example, a manager of a casino floor might be able to change the location of slot machines by dragging rectangles or other iconic representations of the machines into their new locations. The floor manager might be able to specify the type of game at each location, or if the machine is a “downloadable game,” specify what game is to be offered by the unit at particular times or specify other configurable attributes of the game. The layout manager may also allow a user to specify environmental attributes for a region of the game floor, such as lighting, displays and signage for individual machines, banks, or regions of the floor. The layout manager might display information about each machine, such as historical performance, either graphically, by labeling, or by a summary data table.

The user may request predictive measures from the analysis engine, such as predicting the performance of a new slot machine to be placed in a new location, or to compare the performance of recent changes with projected performance of the previous layout, and use these predictive measures to assist in designing the floor. The layout manager may also allow the user to request predictions about optimal location to place a new game on the floor, or possibly suggest new floor layouts that optimize revenue, cost, profit, and display those predictions. During the design process, or upon completion of a design, the layout manager may check for errors such as slot machine cabinets oriented incorrectly, aisles between slot machine banks which are too narrow, or configurations which do not meet regulatory requirements, and alert the user to those errors. The layout manager may also check for and warn about less serious problems, such as banks with mismatched game types (such as video poker and reel games mixed together in a bank). The layout manager may allow the user to restrict the data displayed or predicted for locations or products by time, customer demographics.

The layout manager may also allow the user to maintain and edit a library of subsets of an overall layout. These subsets might be single web pages within an online store, or slot banks in a casino. For example, a chain of retail stores may have different overall layouts within each store, but the product displays for each type of product within the store have a standard form. The layout manager would allow the user to compile a library consisting of the standard displays (perhaps one for men's jeans, another for men's shirts, and so forth) and then for each store, these displays could be arranged as units within each store without having to specify the location of each product on each shelf of each display in each store. The layout manager may also allow changes to a subset of the library to be propagated automatically to some or all business location plans that use that subset. For example, if the layout designer changes the arrangement of jeans on the standard display for men's jeans in a store, then these changes could be automatically spread by the layout manager to all store layouts containing the men's jeans display, creating new layouts for those stores.

The layout manager may also generate a subset of the layout based upon general specifications made by the user. For example, a slot floor manager may indicate that they want to create a bank containing a certain number of machines, having certain properties such as denomination, using machines that are presently available, and have the layout manager create a bank which satisfies those requirements as best as possible. The layout manager may allow a user to specify that certain areas of the layout have themes or styles, and then create a layout which matches the specified theme or style. For example, a slot floor manager may designate a certain area of the casino to be the “video poker room” and then the layout manager will arrange the layout so that that area only contains video poker machines.

The layout manager may also allow the user to maintain and edit a library of layouts. The layout manager may allow the user to specify a timetable for the application of those layouts. For example, in a casino which has slot machines which can have the games they play changed remotely, the layout manager may allow the users to specify a timetable of layouts where the games on the slot machines change at various times to reflect the preferred games of the various demographic groups which play slot machines at various times of the day. The layout manager may allow the user to scroll through a such a sequence of layouts specified by time of day using a slider, scroll-bar or similar control. The slider could also allow scrolling through different days of the week or other time periods. The layout manager could also display a map of a geographical region indicating the locations of various business locations for which layouts can be designed. A user could select the location they wish to edit by clicking on the indicated point for on the map.

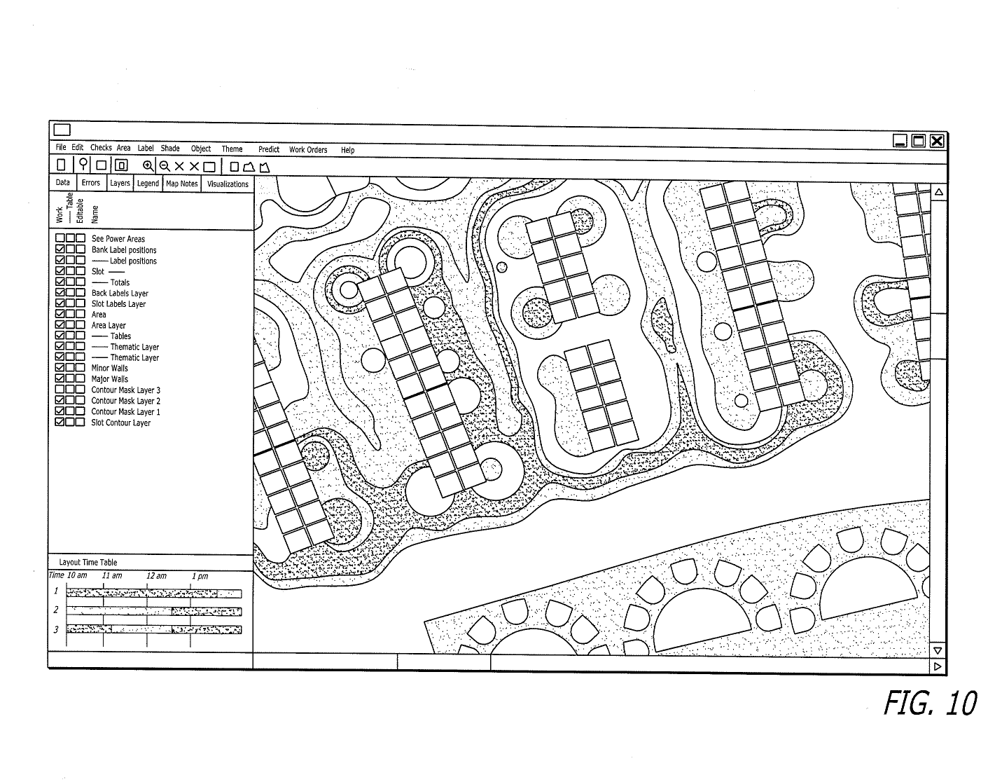

FIG. 10 shows a visual representation of a preferred form layout manager.

Shown in FIG. 10 is:
A menubar which allows the user to select various actions to perform.
A toolbar which gives tools and options for creating and editing objects within the layout,
A series of tabs on the left of the screen, displaying information and options for the current layout which can be selected by a user
A scrolling timetable which allows the user to select which parts of which layout will be in effect at any given time
A primary work area in which the layout and other relevant data is displayed.

The user can:
Create, move, edit the shape of, or otherwise change the layout of objects on the slot floor using a combination of the tabs, toolbars and menus in a manner similar to that described in CO002
Select objects or areas on the floor using the mouse, and set their properties using the Object or Area menus
Generate a workorder for the changes they have made by selecting an option from the workorders menu. There may be several types of worksheets that can be generated, and the user can select which type they wish to use. The request to generate the worksheet will be sent to the layout management system for processing.
Choose data to visualize by selecting the visualization tab on the left hand side and choosing a visualization. If they do not wish to visualize the data they can uncheck the appropriate layers in the layers tab. A sample visualization is shown in the main portion of the window, illustrating data which is displayed as contours, shading and labels. A website layout manager might display the layout as a hierarchical tree, or a network, showing the overall structure of the website, with the data displayed on top of that. If a required visualization is not available in the data store, the user can click on a button or select a menu item and the layout manager wilt query the user for the required parameters, send a request to the analysis engine to produce it, and display the results returned by the analysis engine.
Data could also be displayed in a table, possibly as an additional tab in the main window (not shown). If the required data is not available in the data store, the user can click on a button or select a menu item and the layout manager will query the user for the required parameters, send a request to the analysis engine to produce it, and display the results returned by the analysis engine.
Individual object, or area histories or data can be viewed by selecting a machine, and selecting the object menu (or perhaps another, separate, menu) and choosing an appropriate option. This might then show the requested data as a graph or summary in a new tab or window. Again, if the data is not immediately available from the data store, the layout manager may request the analysis engine to produce the requested data.
Select an object, or group of objects, or area, and request a prediction from the Predict menu. This menu will offer appropriate prediction options reflecting the capabilities of the analysis engine. The layout manager wilt present a wizard or series of dialog boxes which allows the user to select the appropriate options for the prediction. The parameters required for the prediction will be sent to the analysis engine, which will return the result. The result may be displayed visually by contouring, shading or labeling, or as a separate display in a tab or window, either as a graph or as tabular data. In the case where the analysis engine is suggesting a predicted optimal choice or layout, the layout manager may simply implement the suggested changes, allowing the user to undo the changes, or it may present the changes in a window and allow the user to accept or reject the changes before changing the layout.
Add objects or groups of objects from a library by selecting the library menu from the toolbar and selecting the object template that they want to add from a library. They may also change objects, groups of objects or areas within the layout to conform to a library selection, by selecting the object or group of objects and then selecting the library template they want to replace it with. Templates in the library can be created by selecting part of an existing layout and saving it to the library, or by creating a new partial layout containing just the objects in the template.
Select a group of objects or area, and select a theme for them by choosing an option from the Theme menu. The layout manager may make changes to the floor plan, which the user could choose to undo, or they may present a list of changes to be made, and allow the user to accept or reject the changes before changing the layout.
Use the layout timetable section to edit particular parts of the layout for particular times, such as time of day, day of week, or time of year. The assigned layouts may be displayed as bars or lines in a scrolling display as illustrated in the lower left corner of the screen, which can be selected, grown or shrunk. There may be one bar for the entire layout, or areas within the layout could be selected to have different partial layouts at different times, as illustrated. The bars could also be labeled by name our other indicator of which layout is suggested for use at a given time.

The foregoing describes the invention including preferred forms thereof.

Modifications and improvements as would be obvious to those skilled in the art are intended to be incorporated in the scope hereof as defined in the accompanying claims.

What we claim is:

1. A spatial data management system comprising:
a spatial database maintained in computer memory, said spatial database including one or more position data sets, said position data set(s) including respective object identifiers, geographical data and date/time data;
an analysis engine configured to retrieve one or more said position data sets from said spatial database and to generate display data at least partly from the retrieved position data set(s); and
a layout manager configured to receive said display data from said analysis engine and to display to a user a graphical spatial representation of said display data.

2. A spatial data management method comprising:
maintaining in computer memory, a spatial database including one or more position data sets, said position data set(s) including respective object identifiers, geographical data and date/time data;
configuring an analysis engine to retrieve one or more said position data sets from said spatial database and to generate display data at least partly from the retrieved position data set(s); and
configuring a layout manager to receive said display data from said analysis engine and to display to a user a graphical spatial representation of said display data.

3. A spatial data management computer program embodied on a computer readable medium comprising:
a spatial database maintained in computer memory, said spatial database including one or more position data sets, said position data set(s) including respective object identifiers, geographical data and date/time data;
an analysis engine configured to retrieve one or more said position data sets from said spatial database and to generate display data at least partly from the retrieved position data set(s); and
a layout manager configured to receive said display data from said analysis engine and to display to a user a graphical spatial representation of said display data.
